(19) United States
(12) Patent Application Publication
(10) Pub. No.: US 2009/0182986 A1
(43) Pub. Date: Jul. 16, 2009

(54) Processing Unit Incorporating Issue Rate-Based Predictive Thermal Management

(76) Inventors: Stephen Joseph Schwinn, Woodbury, MN (US); Matthew Ray Tubbs, Rochester, MN (US); Charles David Wait, Byron, MN (US)

Correspondence Address: WOOD, HERRON & EVANS, L.L.P. (IBM), 2700 CAREW TOWER, 441 VINE STREET, CINCINNATI, OH, 45202, US

(21) Appl. No.: 12/015,174

(22) Filed: Jan. 16, 2008

(51) Int. Cl. G06F 9/30

(52) U.S. Cl. 712/214; 712/E09.016

(57) ABSTRACT

A circuit arrangement and method utilize an issue rate-based predictive thermal management technique in a microprocessor or other integrated circuit that tracks the rate in which instructions are issued to one or more execution units in the processing unit, and selectively delays the issuance of subsequent instructions to the execution unit(s) based upon the tracked issue rate to predictively control the thermal output of the integrated circuit.

### FIELD OF THE INVENTION

The invention is generally related to data processing, and in particular to processor architectures and thermal management of same.

### BACKGROUND OF THE INVENTION

As semiconductor technology continues to inch closer to practical limitations in terms of increases in clock speed, architects are increasingly focusing on parallelism in processor architectures to obtain performance improvements. At the chip level, multiple processor cores are often disposed on the same chip, functioning in much the same manner as separate processor chips, or to some extent, as completely separate computers. In addition, even within cores, parallelism is employed through the use of multiple execution units that are specialized to handle certain types of operations. Pipelining is also employed in many instances so that certain operations that may take multiple clock cycles to perform are broken up into stages, enabling other operations to be started prior to completion of earlier operations. Multithreading is also employed to enable multiple instruction streams to be processed in parallel, enabling more overall work to performed in any given clock cycle.

Pipelining can have a significant impact on the performance of a microprocessor or other processing unit. For example, in an N stage pipeline, where a given instruction takes N clock cycles to complete execution by the pipeline, up to N instructions may be at different stages of execution in the pipeline and being processed by different circuitry in the pipeline. In particular, a new instruction is typically able to enter the pipeline each successive clock cycle. In contrast, were the logic used to execute the instructions not pipelined, each instruction would still take N cycles to execute, but the next instruction could not begin execution until N cycles after execution of the first instruction was initiated. Instruction execution performance in an N-stage pipeline can theoretically reach N times the performance of equivalent non-pipelined circuitry; however, due to instruction dependencies, and branches in the instruction stream, this level of performance is rarely reached. Nonetheless, with execution unit pipelines of 5, 10 or even larger numbers of stages, the gains that may be obtained as a result of pipelining can be substantial.

One significant concern that that has always arisen with microprocessors and integrated circuits or chips in general is that of thermal management. As the number of transistors on a chip increases, and as the clock frequency of a chip increases, the amount of heat generated by that chip likewise increases. While many computer systems incorporate external cooling systems to assist with dissipating heat generated during the operation of a chip, substantial efforts have also been expended toward on-chip thermal management.

As an example, many modern microprocessors employ thermal protection that prevents damage to a chip by disabling fully pipelined execution once a thermal threshold has been detected as determined by a temperature sensor. When a microprocessor is in this mode, instructions are issued to an execution unit and allowed to proceed down the pipeline alone, while newer instructions are stalled until the first instruction completes. The issued instruction fully completes and exits the pipeline before the next instruction is issued. This reduces switching due to the inactive stages of the pipeline, which in turn reduces power consumption and heat. The pipelined execution resumes when the temperature sensor has detected that the temperature has returned to a lower level.

However, it has been found that disabling fully pipelined execution in a microprocessor often hampers overall performance and lacks configurability. When processors are in a single issue thermal throttle mode, opportunities to issue instructions in subsequent cycles before completion of the first instruction are lost, and these instructions must be issued later, which significantly decreases performance.

In addition, in many cases the temperature threshold used to trigger a switch to a single issue thermal throttle mode must be set significantly lower than the temperature that would damage the chip, because there is always some lag in the effect of switching an execution unit to single issue thermal throttle mode. Were the threshold set at a level close to the level at which damage occurs, the temperature of the chip might continue to climb past the point of no return before the effects of switching the mode of the execution unit were realized. Performance and temperature typically track one another, and as such, the margin between the threshold and the temperature at which a chip is damaged often represents a loss of potential performance.

Another issue is that of configurability. A microprocessor manufacturer may choose to design one processor to fit a variety of applications used in different operating environments as opposed to multiple designs to save cost. However, operating environments and applications vary considerably for microprocessors. Some applications and environments might allow for very high local temperatures due to available liquid cooling, while some other applications might have more stringent thermal requirements such as portable applications (example: laptops) where large fans or liquid cooling pumps are not ideal. If a temperature sensor is designed to have one threshold temperature for all environments and applications, the flexibility of the design is significantly limited.

Therefore, a significant need continues to exist in the art for improving the thermal management of microprocessors and other integrated circuits.

### SUMMARY OF THE INVENTION

The invention addresses these and other problems associated with the prior art by providing a circuit arrangement and method that utilize an issue rate-based predictive thermal management technique in a microprocessor or other integrated circuit that tracks the rate in which instructions are issued to one or more execution units in the processing unit, and selectively delays the issuance of subsequent instructions to the execution unit(s) based upon the tracked issue rate to predictively control the thermal output of the integrated circuit.

The selective delay of instruction issuance may be implemented in some embodiments, for example, by selectively inserting bubbles into a pipelined execution unit responsive to a tracked rate of issue of instructions to the execution unit by issue logic. By doing so, switching in the pipelined execution unit is reduced, thus reducing power consumption and thermal output. In addition, while the illustrated embodiments utilize the herein-described issue rate-based technique for the purpose of thermal management, it will be appreciated by those of ordinary skill in the art that the technique may be utilized in an integrated circuit for reasons other than thermal management.

Consistent with one aspect of the invention, a circuit arrangement is provided, including an execution unit, issue logic coupled to the execution unit and configured to issue instructions to the execution unit, and control logic coupled to the issue logic and configured to track a rate of issue of instructions to the execution unit by the issue logic and to cause the issue logic to selectively delay issuance of instructions to the execution unit based upon the tracked rate of issue of instructions.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of exemplary automated computing machinery including an exemplary computer useful in data processing consistent with embodiments of the present invention.

FIG. 2 is a block diagram of an exemplary NOC implemented in the computer of FIG. 1.

FIG. 3 is a block diagram illustrating in greater detail an exemplary implementation of a node from the NOC of FIG. 2.

FIG. 4 is a block diagram illustrating an exemplary implementation of an IP block from the NOC of FIG. 2.

FIG. 5 is a block diagram of a processing unit incorporating an issue rate-based thermal control unit consistent with the invention, and capable of being implemented within an IP block from the NOC of FIG. 2.

FIG. 6 is a block diagram of an exemplary implementation of the issue rate reduction control logic referenced in FIG. 5.

FIG. 7 is a flowchart illustrating a thermal monitoring routine capable of being executed by the processing unit of FIG. 5.

FIG. 8 is a graph illustrating temperature over time for an exemplary integrated circuit that implements a conventional single issue thermal throttle thermal management technique.

FIG. 9 is a graph illustrating temperature over time for an exemplary integrated circuit that implements a issue rate-based thermal management technique consistent with the invention.

FIG. 10 is a block diagram of an alternate implementation of the issue rate reduction control logic to that illustrated in FIG. 6.

FIG. 11 is a block diagram of an alternate implementation of a processing unit incorporating an issue rate-based thermal control unit to that illustrated in FIG. 5.

### DETAILED DESCRIPTION

Embodiments consistent with the invention utilize an issue rate-based predictive thermal management technique in a microprocessor or other integrated circuit to track the rate in which instructions are issued to one or more execution units in the processing unit, and selectively delay the issuance of subsequent instructions to the execution unit(s) based upon the tracked issue rate to predictively control the thermal output of the integrated circuit.

In contrast with conventional on-chip thermal management techniques that exclusively use a thermal sensor to detect if a processor has reached some threshold and switch to a single issue thermal throttle mode to fully disable pipelining, the illustrated embodiments allow for a more proactive and highly configurable approach that selectively inserts bubbles into a pipelined execution unit based upon a tracked rate of issue of instructions by the issue logic that feeds the execution unit.

In particular, to prevent high power consumption and thermal runaway that can damage circuitry, embodiments consistent with the invention attempt to predict a behavior trend in a microprocessor that may result in high localized temperature, by providing feedback to a processing unit's issue logic to cause it to throttle back performance dynamically and with a high degree of granularity such that the performance loss is minimized, while still protecting from thermal damage. Effectively, embodiments of the invention use instruction history as a predictor of future temperature in a circuit, thus enabling greater responsiveness and improved performance over techniques that rely exclusively on a thermal sensor.

The illustrated embodiments, in particular, utilize control logic that interfaces an execution unit and the issue logic that issues instructions to the execution unit. The control logic performs two related functions, tracking the rate of issue of instructions to the execution unit by the issue unit, and controlling the issue logic to selectively delay issuance of instructions to the execution unit based upon the tracked rate of issue of instructions.

The issue rate for the issue logic can be tracked and represented in a number of manners consistent with the invention. In one embodiment, for example, a rate is determined by tracking the number of instructions that are issued to the execution unit over a window, e.g., of 100 or 1000 processor cycles, or as a percentage of cycles in a window in which an instruction was issued. The number or percentage may also be represented by an encoded value to represent a range of numbers or percentages (e.g., a two-bit code could represent issue rates of 0-24%, 25-49%, 50-74% and 75-100%). Issue rate may be based upon the number of consecutive cycles in which an instruction is issued, or may be based upon one or more counters, e.g., a counter that is incremented each cycle in which an instruction is issued and decremented each cycle in which no instruction is issued, or separate counters that log the number of instructions issued and the number of cycles in which no instruction is issued. It will be appreciated by one of ordinary skill in the art having the benefit of the instant disclosure that an issue rate may be based upon other metrics that are generally indicative of the level of activity that is occurring within an execution unit at any given time. In addition, the herein-described techniques may also be used to monitor other operations that are indicative of power consumption, e.g., the rate of loads and stores, the rate of hits or misses to a cache, etc.

In this regard, it may also be desirable to weight certain types of instructions relative to other types of instructions based upon the amount of switching, and thus the amount of power dissipation and heat generation, typically associated with such instructions. Particularly when issue rate-based predictive thermal management is used to track issue rate into multiple execution units, e.g. a floating point unit and a fixed point unit, the amount of power dissipation exhibited by different instructions can vary substantially, and as such, it may be desirable to track different types of instructions separately, or to weight different types of instructions to account for the varying effects on power dissipation.

Control over the issue logic to selectively delay issuance of instructions to the execution unit based upon the tracked rate of issue of instructions can also vary in different embodiments of the invention. The control of the issue logic is typically a function of the tracked rate of issue of instructions. In addition, as discussed above, in the illustrated embodiments, where a pipelined execution unit is used, the selective delay is implemented by inserting bubbles into an instruction stream being issued to an execution unit, such that the bubbles, as they progress through the pipelined execution unit, effectively disable stages in the pipeline as no switching (or a reduced amount of switching) is required to process such bubbles in a stage. It will be appreciated by one of ordinary skill in the art having the benefit of the instant disclosure that a pipelined execution unit consistent with the invention may be designed in such a manner as to minimize the switching and power consumption in each stage of the pipelined execution unit whenever a bubble in the instruction stream is currently present in that stage (i.e., when that stage is not currently operating on an active instruction in the instruction stream). In other implementations, e.g., implementations that do not incorporate pipelined execution units, other techniques may be used to selectively delay the issuance of instructions to an execution unit, e.g., stalling a non-pipelined execution unit to not accept an instruction until after the following clock cycle or multiple clock cycles. In addition, power gating may be used in some implementations.

In addition, the selective delay in issuance may be based on the tracked issue rate in a number of manners. For example, in the illustrated embodiments, while a single threshold may be used, it is desirable to define one or more thresholds that trigger different levels of throttling of the issue rate to an execution unit, thus providing greater granularity and finer grained control. Thresholds may be programmable, and may be responsive to other feedback, e.g., an external or on-chip thermal sensor, a time of day, a current electric rate, a laptop on battery or plug-in power, or other user configuration or OS determined aggregate software load/utilization/“busy-ness” indications, such that the degree in which an execution unit is throttled back can be varied based upon other environmental conditions.

Control over the issue logic may be referred to herein by issue availability rate, which represents how often the issue logic is enabled by the control logic to issue instructions over a given time period. The rate is termed an availability rate because in some instances the issue logic may not issue an instruction even when so enabled by the control logic, e.g., in response to a dependency or branch. Thus, for example, the control logic may enable the issue logic to operate with a 33% issue availability rate, where the issue logic is permitted to issue instructions in at most 33% of the cycles in a given time period, even though the issue logic may issue less instructions over that time period. In addition, in order to support finer grained control, it is desirable in many embodiments to support more than two issue availability rates, thus providing multiple degrees of throttling.

The combination of tracking the issue rate and selectively delaying the issuance of instructions provides a flexible, responsive, accurate and highly configurable manner of providing thermal management in an integrated circuit. While these techniques could be used independent of one another, in the illustrated embodiments, tracking the issue rate typically provides a more accurate and responsive indication of the power consumption of an execution unit than other techniques, e.g. a thermal sensor, given that temperatures determined via thermal sensors, for example, typically lag the actual temperature of the integrated circuit—due both to the delay of the thermal sensor itself, as well as to natural thermal time constant lag consistent with the thermal mass of the chip itself. In contrast, detection of a particularly high issue rate to an execution unit can indicate that the temperature of an integrated circuit is about to rise well before the rise actually occurs, and thus can begin to throttle back the processing unit to counteract the temperature rise. In addition, given that, even when a pipelined execution unit is not being throttled, bubbles will still exist in an execution unit due to instruction dependencies and branches, tracking the actual issue rate provides a more accurate indication of the relative activity occurring in an execution unit at any given time. It will also be appreciated that the herein-described techniques may also be used in connection with other techniques, e.g., a thermal sensor may be used as an additional form of feedback.

The additional responsiveness and accuracy provided by the illustrated embodiments also may be utilized to increase performance, as temperature thresholds may be set at more aggressive levels than are typically utilized in techniques that rely on thermal sensors. In addition, the same basic design can be adapted for use in different operating environments, thus eliminating the need to design a circuit for the worst case thermal conditions. Typically, embodiments consistent with the invention are able to reach a steady state condition for different operating environments so that, for example, in instances where external cooling is used, the performance level of the circuit may adaptively increase to take advantage of the improved heat dissipation characteristics of the operating environment.

In addition, while the illustrated embodiments utilize the herein-described techniques for thermal management, it will be appreciated that the tracking of instruction rate and/or the selective delay in issuance of instructions may be utilized for other purposes consistent with the invention, e.g., to control power consumption in portable electronics, to limit performance for certain users in a multi-user system, to help in resolving deadlocks and livelocks, to equalize thread performance (e.g., preventing one thread from hogging all the issue cycles in a unit), to balance power consumption among processors in a large multi-processor environment, to eliminate cooling ‘hot-spots’, etc.

Other modifications will be apparent to one of ordinary skill in the art. Therefore, the invention is not limited to the specific implementations discussed herein.

### Hardware and Software Environment

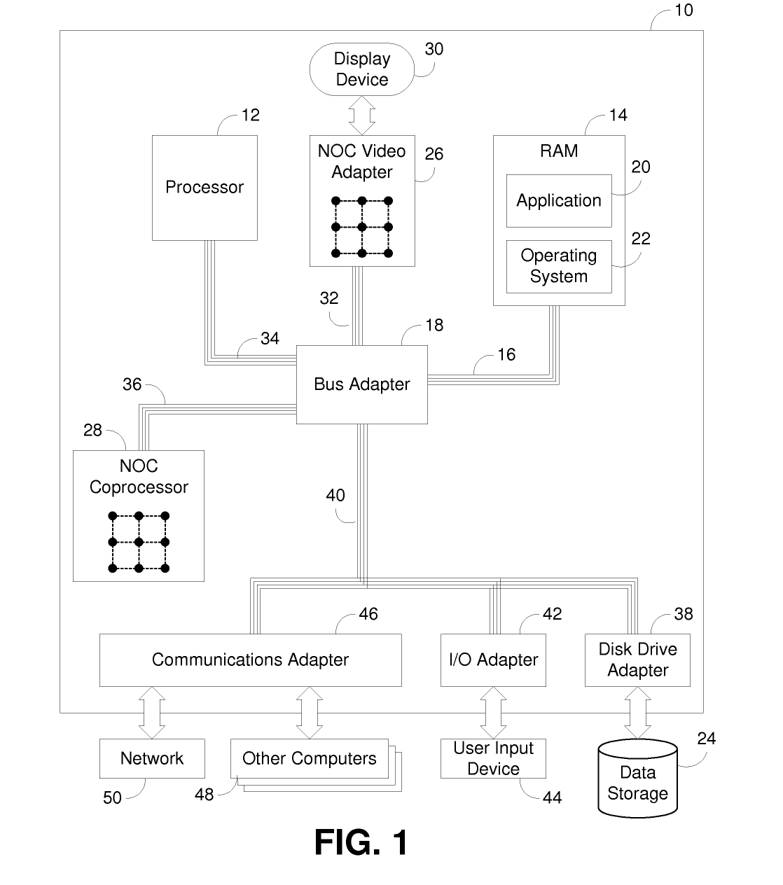

Now turning to the drawings, wherein like numbers denote like parts throughout the several views, FIG. 1 illustrates exemplary automated computing machinery including an exemplary computer 10 useful in data processing consistent with embodiments of the present invention. Computer 10 of FIG. 1 includes at least one computer processor 12 or ‘CPU’ as well as random access memory 14 (‘RAM’), which is connected through a high speed memory bus 16 and bus adapter 18 to processor 12 and to other components of the computer 10.

Stored in RAM 14 is an application program 20, a module of user-level computer program instructions for carrying out particular data processing tasks such as, for example, word processing, spreadsheets, database operations, video gaming, stock market simulations, atomic quantum process simulations, or other user-level applications. Also stored in RAM 14 is an operating system 22. Operating systems useful in connection with embodiments of the invention include UNIX™, Linux™, Microsoft Windows XP™, AIX™, IBM's i5/OS™, and others as will occur to those of skill in the art. Operating system 22 and application 20 in the example of FIG. 1 are shown in RAM 14, but many components of such software typically are stored in non-volatile memory also, e.g., on a disk drive 24.

As will become more apparent below, embodiments consistent with the invention may be implemented within Network On Chip (NOC) integrated circuit devices, or chips, and as such, computer 10 is illustrated including two exemplary NOCs: a video adapter 26 and a coprocessor 28. NOC video adapter 26, which may alternatively be referred to as a graphics adapter, is an example of an I/O adapter specially designed for graphic output to a display device 30 such as a display screen or computer monitor. NOC video adapter 26 is connected to processor 12 through a high speed video bus 32, bus adapter 18, and the front side bus 34, which is also a high speed bus. NOC Coprocessor 28 is connected to processor 12 through bus adapter 18, and front side buses 34 and 36, which is also a high speed bus. The NOC coprocessor of FIG. 1 may be optimized, for example, to accelerate particular data processing tasks at the behest of the main processor 12.

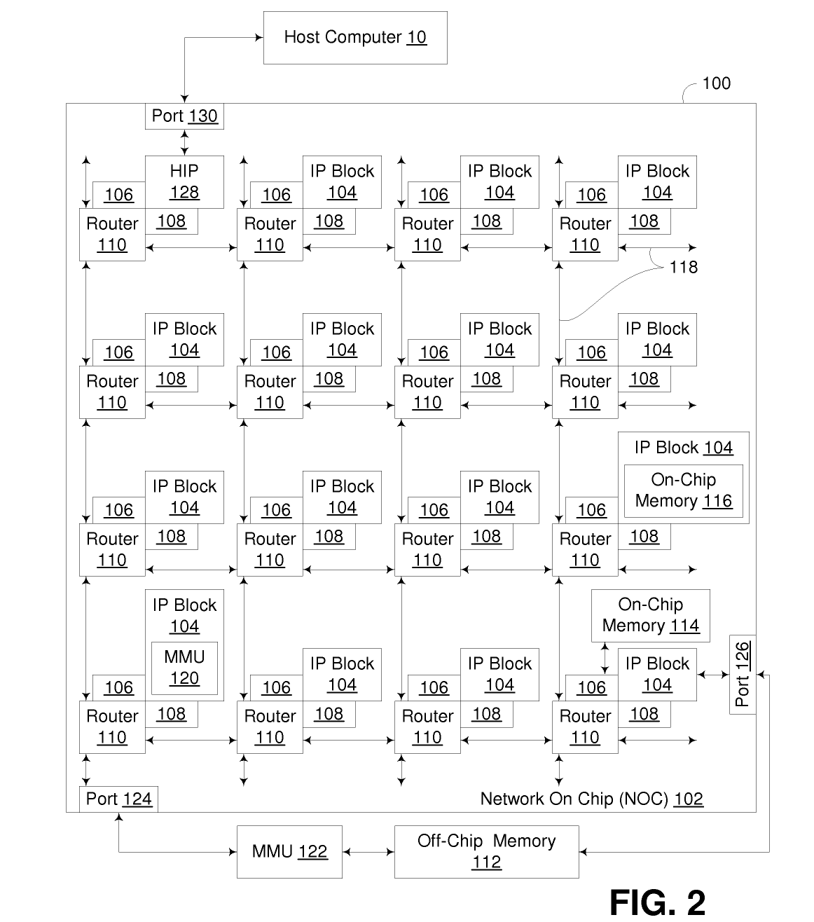

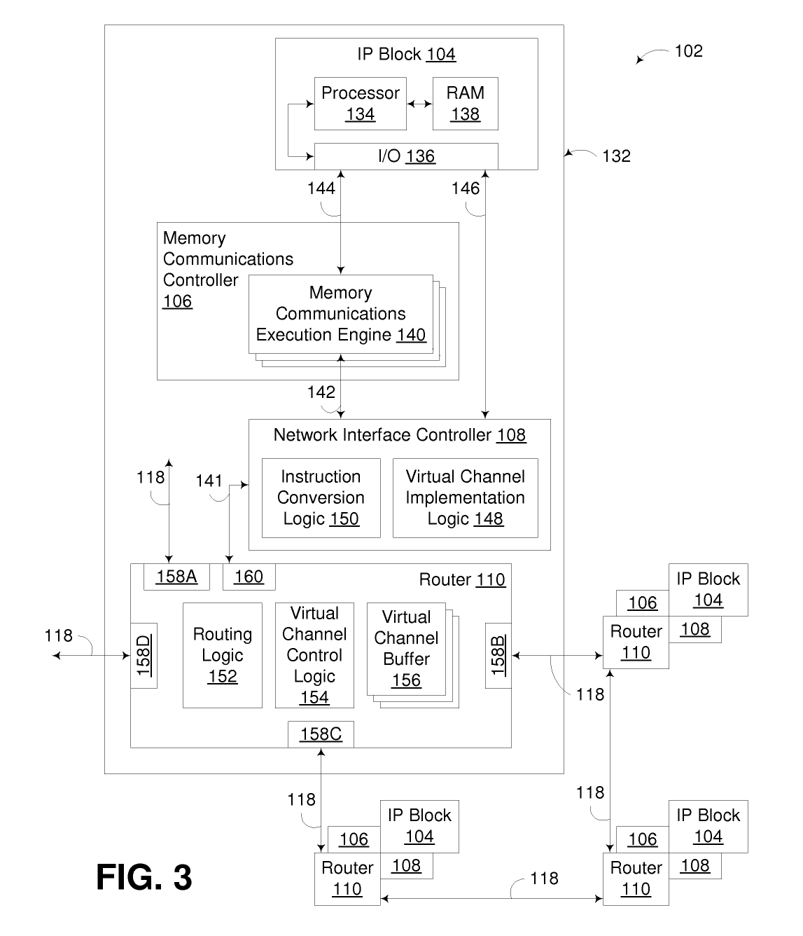

The exemplary NOC video adapter 26 and NOC coprocessor 28 of FIG. 1 each include a NOC, including integrated processor (‘IP’) blocks, routers, memory communications controllers, and network interface controllers, the details of which will be discussed in greater detail below in connection with FIGS. 2-3. The NOC video adapter and NOC coprocessor are each optimized for programs that use parallel processing and also require fast random access to shared memory. It will be appreciated by one of ordinary skill in the art having the benefit of the instant disclosure, however, that the invention may be implemented in devices and device architectures other than NOC devices and device architectures. The invention is therefore not limited to implementation within an NOC device.

Computer 10 of FIG. 1 includes disk drive adapter 38 coupled through an expansion bus 40 and bus adapter 18 to processor 12 and other components of the computer 10. Disk drive adapter 38 connects non-volatile data storage to the computer 10 in the form of disk drive 24, and may be implemented, for example, using Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

Computer 10 also includes one or more input/output (‘I/O’) adapters 42, which implement user-oriented input/output through, for example, software drivers and computer hardware for controlling output to display devices such as computer display screens, as well as user input from user input devices 44 such as keyboards and mice. In addition, computer 10 includes a communications adapter 46 for data communications with other computers 48 and for data communications with a data communications network 50. Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters suitable for use in computer 10 include modems for wired dial-up communications, Ethernet (IEEE 802.3) adapters for wired data communications network communications, and 802.11 adapters for wireless data communications network communications.

For further explanation, FIG. 2 sets forth a functional block diagram of an example NOC 102 according to embodiments of the present invention. The NOC in FIG. 2 is implemented on a ‘chip’ 100, that is, on an integrated circuit. NOC 102 includes integrated processor (‘IP’) blocks 104, routers 110, memory communications controllers 106, and network interface controllers 108 grouped into interconnected nodes. Each IP block 104 is adapted to a router 110 through a memory communications controller 106 and a network interface controller 108. Each memory communications controller controls communications between an IP block and memory, and each network interface controller 108 controls inter-IP block communications through routers 110.

In NOC 102, each IP block represents a reusable unit of synchronous or asynchronous logic design used as a building block for data processing within the NOC. The term ‘IP block’ is sometimes expanded as ‘intellectual property block,’ effectively designating an IP block as a design that is owned by a party, that is the intellectual property of a party, to be licensed to other users or designers of semiconductor circuits. In the scope of the present invention, however, there is no requirement that IP blocks be subject to any particular ownership, so the term is always expanded in this specification as ‘integrated processor block.’ IP blocks, as specified here, are reusable units of logic, cell, or chip layout design that may or may not be the subject of intellectual property. IP blocks are logic cores that can be formed as ASIC chip designs or FPGA logic designs.

One way to describe IP blocks by analogy is that IP blocks are for NOC design what a library is for computer programming or a discrete integrated circuit component is for printed circuit board design. In NOCs consistent with embodiments of the present invention, IP blocks may be implemented as generic gate netlists, as complete special purpose or general purpose microprocessors, or in other ways as may occur to those of skill in the art. A netlist is a Boolean-algebra representation (gates, standard cells) of an IP block's logical-function, analogous to an assembly-code listing for a high-level program application. NOCs also may be implemented, for example, in synthesizable form, described in a hardware description language such as Verilog or VHDL. In addition to netlist and synthesizable implementation, NOCs also may be delivered in lower-level, physical descriptions. Analog IP block elements such as SERDES, PLL, DAC, ADC, and so on, may be distributed in a transistor-layout format such as GDSII. Digital elements of IP blocks are sometimes offered in layout format as well. It will also be appreciated that IP blocks, as well as other logic circuitry implemented consistent with the invention may be distributed in the form of computer data files, e.g., logic definition program code, that define at various levels of detail the functionality and/or layout of the circuit arrangements implementing such logic. Thus, while the invention has and hereinafter will be described in the context of circuit arrangements implemented in fully functioning integrated circuit devices and data processing systems utilizing such devices, those of ordinary skill in the art having the benefit of the instant disclosure will appreciate that circuit arrangements consistent with the invention are capable of being distributed as program products in a variety of forms, and that the invention applies equally regardless of the particular type of computer readable or signal bearing media being used to actually carry out the distribution. Examples of computer readable or signal bearing media include, but are not limited to, physical, recordable type media such as volatile and non-volatile memory devices, floppy disks, hard disk drives, CD-ROMs, and DVDs (among others), and transmission type media such as digital and analog communication links.

Each IP block 104 in the example of FIG. 2 is adapted to a router 110 through a memory communications controller 106. Each memory communication controller is an aggregation of synchronous and asynchronous logic circuitry adapted to provide data communications between an IP block and memory. Examples of such communications between IP blocks and memory include memory load instructions and memory store instructions. The memory communications controllers 106 are described in more detail below with reference to FIG. 3. Each IP block 104 is also adapted to a router 110 through a network interface controller 108, which controls communications through routers 110 between IP blocks 104. Examples of communications between IP blocks include messages carrying data and instructions for processing the data among IP blocks in parallel applications and in pipelined applications. The network interface controllers 108 are also described in more detail below with reference to FIG. 3.

Routers 110, and the corresponding links 118 therebetween, implement the network operations of the NOC. The links 118 may be packet structures implemented on physical, parallel wire buses connecting all the routers. That is, each link may be implemented on a wire bus wide enough to accommodate simultaneously an entire data switching packet, including all header information and payload data. If a packet structure includes 64 bytes, for example, including an eight byte header and 56 bytes of payload data, then the wire bus subtending each link is 64 bytes wide, 512 wires. In addition, each link may be bidirectional, so that if the link packet structure includes 64 bytes, the wire bus actually contains 1024 wires between each router and each of its neighbors in the network. In such an implementation, a message could include more than one packet, but each packet would fit precisely onto the width of the wire bus. In the alternative, a link may be implemented on a wire bus that is only wide enough to accommodate a portion of a packet, such that a packet would be broken up into multiple beats, e.g., so that if a link is implemented as 16 bytes in width, or 128 wires, a 64 byte packet could be broken into four beats. It will be appreciated that different implementations may used different bus widths based on practical physical limits as well as desired performance characteristics. If the connection between the router and each section of wire bus is referred to as a port, then each router includes five ports, one for each of four directions of data transmission on the network and a fifth port for adapting the router to a particular IP block through a memory communications controller and a network interface controller.

Each memory communications controller 106 controls communications between an IP block and memory. Memory can include off-chip main RAM 112, memory 114 connected directly to an IP block through a memory communications controller 106, on-chip memory enabled as an IP block 116, and on-chip caches. In NOC 102, either of the on-chip memories 114, 116, for example, may be implemented as on-chip cache memory. All these forms of memory can be disposed in the same address space, physical addresses or virtual addresses, true even for the memory attached directly to an IP block. Memory addressed messages therefore can be entirely bidirectional with respect to IP blocks, because such memory can be addressed directly from any IP block anywhere on the network. Memory 116 on an IP block can be addressed from that IP block or from any other IP block in the NOC. Memory 114 attached directly to a memory communication controller can be addressed by the IP block that is adapted to the network by that memory communication controller—and can also be addressed from any other IP block anywhere in the NOC.

NOC 102 includes two memory management units (‘MMUs’) 120, 122, illustrating two alternative memory architectures for NOCs consistent with embodiments of the present invention. MMU 120 is implemented within an IP block, allowing a processor within the IP block to operate in virtual memory while allowing the entire remaining architecture of the NOC to operate in a physical memory address space. MMU 122 is implemented off-chip, connected to the NOC through a data communications port 124. The port 124 includes the pins and other interconnections required to conduct signals between the NOC and the MMU, as well as sufficient intelligence to convert message packets from the NOC packet format to the bus format required by the external MMU 122. The external location of the MMU means that all processors in all IP blocks of the NOC can operate in virtual memory address space, with all conversions to physical addresses of the off-chip memory handled by the off-chip MMU 122.

In addition to the two memory architectures illustrated by use of the MMUs 120, 122, data communications port 126 illustrates a third memory architecture useful in NOCs capable of being utilized in embodiments of the present invention. Port 126 provides a direct connection between an IP block 104 of the NOC 102 and off-chip memory 112. With no MMU in the processing path, this architecture provides utilization of a physical address space by all the IP blocks of the NOC. In sharing the address space bi-directionally, all the IP blocks of the NOC can access memory in the address space by memory-addressed messages, including loads and stores, directed through the IP block connected directly to the port 126. The port 126 includes the pins and other interconnections required to conduct signals between the NOC and the off-chip memory 112, as well as sufficient intelligence to convert message packets from the NOC packet format to the bus format required by the off-chip memory 112.

In the example of FIG. 2, one of the IP blocks is designated a host interface processor 128. A host interface processor 128 provides an interface between the NOC and a host computer 10 in which the NOC may be installed and also provides data processing services to the other IP blocks on the NOC, including, for example, receiving and dispatching among the IP blocks of the NOC data processing requests from the host computer. A NOC may, for example, implement a video graphics adapter 26 or a coprocessor 28 on a larger computer 10 as described above with reference to FIG. 1. In the example of FIG. 2, the host interface processor 128 is connected to the larger host computer through a data communications port 130. The port 130 includes the pins and other interconnections required to conduct signals between the NOC and the host computer, as well as sufficient intelligence to convert message packets from the NOC to the bus format required by the host computer 10. In the example of the NOC coprocessor in the computer of FIG. 1, such a port would provide data communications format translation between the link structure of the NOC coprocessor 28 and the protocol required for the front side bus 36 between the NOC coprocessor 28 and the bus adapter 18.

FIG. 3 next illustrates a functional block diagram illustrating in greater detail the components implemented within an IP block 104, memory communications controller 106, network interface controller 108 and router 110 in NOC 102, collectively illustrated at 132. IP block 104 includes a computer processor 134 and I/O functionality 136. In this example, computer memory is represented by a segment of random access memory (‘RAM’) 138 in IP block 104. The memory, as described above with reference to FIG. 2, can occupy segments of a physical address space whose contents on each IP block are addressable and accessible from any IP block in the NOC. The processors 134, I/O capabilities 136, and memory 138 in each IP block effectively implement the IP blocks as generally programmable microcomputers. As explained above, however, in the scope of the present invention, IP blocks generally represent reusable units of synchronous or asynchronous logic used as building blocks for data processing within a NOC. Implementing IP blocks as generally programmable microcomputers, therefore, although a common embodiment useful for purposes of explanation, is not a limitation of the present invention.

In NOC 102 of FIG. 3, each memory communications controller 106 includes a plurality of memory communications execution engines 140. Each memory communications execution engine 140 is enabled to execute memory communications instructions from an IP block 104, including bidirectional memory communications instruction flow 141, 142, 144 between the network and the IP block 104. The memory communications instructions executed by the memory communications controller may originate, not only from the IP block adapted to a router through a particular memory communications controller, but also from any IP block 104 anywhere in NOC 102. That is, any IP block in the NOC can generate a memory communications instruction and transmit that memory communications instruction through the routers of the NOC to another memory communications controller associated with another IP block for execution of that memory communications instruction. Such memory communications instructions can include, for example, translation lookaside buffer control instructions, cache control instructions, barrier instructions, and memory load and store instructions.

Each memory communications execution engine 140 is enabled to execute a complete memory communications instruction separately and in parallel with other memory communications execution engines. The memory communications execution engines implement a scalable memory transaction processor optimized for concurrent throughput of memory communications instructions. Memory communications controller 106 supports multiple memory communications execution engines 140 all of which run concurrently for simultaneous execution of multiple memory communications instructions. A new memory communications instruction is allocated by the memory communications controller 106 to a memory communications engine 140 and memory communications execution engines 140 can accept multiple response events simultaneously. In this example, all of the memory communications execution engines 140 are identical. Scaling the number of memory communications instructions that can be handled simultaneously by a memory communications controller 106, therefore, is implemented by scaling the number of memory communications execution engines 140.

In NOC 102 of FIG. 3, each network interface controller 108 is enabled to convert communications instructions from command format to network packet format for transmission among the IP blocks 104 through routers 110. The communications instructions may be formulated in command format by the IP block 104 or by memory communications controller 106 and provided to the network interface controller 108 in command format. The command format may be a native format that conforms to architectural register files of IP block 104 and memory communications controller 106. The network packet format is typically the format required for transmission through routers 110 of the network. Each such message is composed of one or more network packets. Examples of such communications instructions that are converted from command format to packet format in the network interface controller include memory load instructions and memory store instructions between IP blocks and memory. Such communications instructions may also include communications instructions that send messages among IP blocks carrying data and instructions for processing the data among IP blocks in parallel applications and in pipelined applications.

In NOC 102 of FIG. 3, each IP block is enabled to send memory-address-based communications to and from memory through the IP block's memory communications controller and then also through its network interface controller to the network. A memory-address-based communications is a memory access instruction, such as a load instruction or a store instruction, that is executed by a memory communication execution engine of a memory communications controller of an IP block. Such memory-address-based communications typically originate in an IP block, formulated in command format, and handed off to a memory communications controller for execution.

Many memory-address-based communications are executed with message traffic, because any memory to be accessed may be located anywhere in the physical memory address space, on-chip or off-chip, directly attached to any memory communications controller in the NOC, or ultimately accessed through any IP block of the NOC—regardless of which IP block originated any particular memory-address-based communication. Thus, in NOC 102, all memory-address-based communications that are executed with message traffic are passed from the memory communications controller to an associated network interface controller for conversion from command format to packet format and transmission through the network in a message. In converting to packet format, the network interface controller also identifies a network address for the packet in dependence upon the memory address or addresses to be accessed by a memory-address-based communication. Memory address based messages are addressed with memory addresses. Each memory address is mapped by the network interface controllers to a network address, typically the network location of a memory communications controller responsible for some range of physical memory addresses. The network location of a memory communication controller 106 is naturally also the network location of that memory communication controller's associated router 110, network interface controller 108, and IP block 104. The instruction conversion logic 150 within each network interface controller is capable of converting memory addresses to network addresses for purposes of transmitting memory-address-based communications through routers of a NOC.

Upon receiving message traffic from routers 110 of the network, each network interface controller 108 inspects each packet for memory instructions. Each packet containing a memory instruction is handed to the memory communications controller 106 associated with the receiving network interface controller, which executes the memory instruction before sending the remaining payload of the packet to the IP block for further processing. In this way, memory contents are always prepared to support data processing by an IP block before the IP block begins execution of instructions from a message that depend upon particular memory content.

In NOC 102 of FIG. 3, each IP block 104 is enabled to bypass its memory communications controller 106 and send inter-IP block, network-addressed communications 146 directly to the network through the IP block's network interface controller 108. Network-addressed communications are messages directed by a network address to another IP block. Such messages transmit working data in pipelined applications, multiple data for single program processing among IP blocks in a SIMD application, and so on, as will occur to those of skill in the art. Such messages are distinct from memory-address-based communications in that they are network addressed from the start, by the originating IP block which knows the network address to which the message is to be directed through routers of the NOC. Such network-addressed communications are passed by the IP block through I/O functions 136 directly to the IP block's network interface controller in command format, then converted to packet format by the network interface controller and transmitted through routers of the NOC to another IP block. Such network-addressed communications 146 are bi-directional, potentially proceeding to and from each IP block of the NOC, depending on their use in any particular application. Each network interface controller, however, is enabled to both send and receive such communications to and from an associated router, and each network interface controller is enabled to both send and receive such communications directly to and from an associated IP block, bypassing an associated memory communications controller 106.

Each network interface controller 108 in the example of FIG. 3 is also enabled to implement virtual channels on the network, characterizing network packets by type. Each network interface controller 108 includes virtual channel implementation logic 148 that classifies each communication instruction by type and records the type of instruction in a field of the network packet format before handing off the instruction in packet form to a router 110 for transmission on the NOC. Examples of communication instruction types include inter-IP block network-address-based messages, request messages, responses to request messages, invalidate messages directed to caches; memory load and store messages; and responses to memory load messages, etc.

Each router 110 in the example of FIG. 3 includes routing logic 152, virtual channel control logic 154, and virtual channel buffers 156. The routing logic typically is implemented as a network of synchronous and asynchronous logic that implements a data communications protocol stack for data communication in the network formed by the routers 110, links 118, and bus wires among the routers. Routing logic 152 includes the functionality that readers of skill in the art might associate in off-chip networks with routing tables, routing tables in at least some embodiments being considered too slow and cumbersome for use in a NOC. Routing logic implemented as a network of synchronous and asynchronous logic can be configured to make routing decisions as fast as a single clock cycle. The routing logic in this example routes packets by selecting a port for forwarding each packet received in a router. Each packet contains a network address to which the packet is to be routed.

In describing memory-address-based communications above, each memory address was described as mapped by network interface controllers to a network address, a network location of a memory communications controller. The network location of a memory communication controller 106 is naturally also the network location of that memory communication controller's associated router 110, network interface controller 108, and IP block 104. In inter-IP block, or network-address-based communications, therefore, it is also typical for application-level data processing to view network addresses as the location of an IP block within the network formed by the routers, links, and bus wires of the NOC. FIG. 2 illustrates that one organization of such a network is a mesh of rows and columns in which each network address can be implemented, for example, as either a unique identifier for each set of associated router, IP block, memory communications controller, and network interface controller of the mesh or x, y coordinates of each such set in the mesh.

In NOC 102 of FIG. 3, each router 110 implements two or more virtual communications channels, where each virtual communications channel is characterized by a communication type. Communication instruction types, and therefore virtual channel types, include those mentioned above: inter-IP block network-address-based messages, request messages, responses to request messages, invalidate messages directed to caches; memory load and store messages; and responses to memory load messages, and so on. In support of virtual channels, each router 110 in the example of FIG. 3 also includes virtual channel control logic 154 and virtual channel buffers 156. The virtual channel control logic 154 examines each received packet for its assigned communications type and places each packet in an outgoing virtual channel buffer for that communications type for transmission through a port to a neighboring router on the NOC.

Each virtual channel buffer 156 has finite storage space. When many packets are received in a short period of time, a virtual channel buffer can fill up—so that no more packets can be put in the buffer. In other protocols, packets arriving on a virtual channel whose buffer is full would be dropped. Each virtual channel buffer 156 in this example, however, is enabled with control signals of the bus wires to advise surrounding routers through the virtual channel control logic to suspend transmission in a virtual channel, that is, suspend transmission of packets of a particular communications type. When one virtual channel is so suspended, all other virtual channels are unaffected—and can continue to operate at full capacity. The control signals are wired all the way back through each router to each router's associated network interface controller 108. Each network interface controller is configured to, upon receipt of such a signal, refuse to accept, from its associated memory communications controller 106 or from its associated IP block 104, communications instructions for the suspended virtual channel. In this way, suspension of a virtual channel affects all the hardware that implements the virtual channel, all the way back up to the originating IP blocks.

One effect of suspending packet transmissions in a virtual channel is that no packets are ever dropped. When a router encounters a situation in which a packet might be dropped in some unreliable protocol such as, for example, the Internet Protocol, the routers in the example of FIG. 3 may suspend by their virtual channel buffers 156 and their virtual channel control logic 154 all transmissions of packets in a virtual channel until buffer space is again available, eliminating any need to drop packets. The NOC of FIG. 3, therefore, may implement highly reliable network communications protocols with an extremely thin layer of hardware.

The example NOC of FIG. 3 may also be configured to maintain cache coherency between both on-chip and off-chip memory caches. Each NOC can support multiple caches each of which operates against the same underlying memory address space. For example, caches may be controlled by IP blocks, by memory communications controllers, or by cache controllers external to the NOC. Either of the on-chip memories 114, 116 in the example of FIG. 2 may also be implemented as an on-chip cache, and, within the scope of the present invention, cache memory can be implemented off-chip also.

Each router 110 illustrated in FIG. 3 includes five ports, four ports 158A-D connected through bus wires 118 to other routers and a fifth port 160 connecting each router to its associated IP block 104 through a network interface controller 108 and a memory communications controller 106. As can be seen from the illustrations in FIGS. 2 and 3, the routers 110 and the links 118 of the NOC 102 form a mesh network with vertical and horizontal links connecting vertical and horizontal ports in each router. In the illustration of FIG. 3, for example, ports 158A, 158C and 160 are termed vertical ports, and ports 158B and 158D are termed horizontal ports.

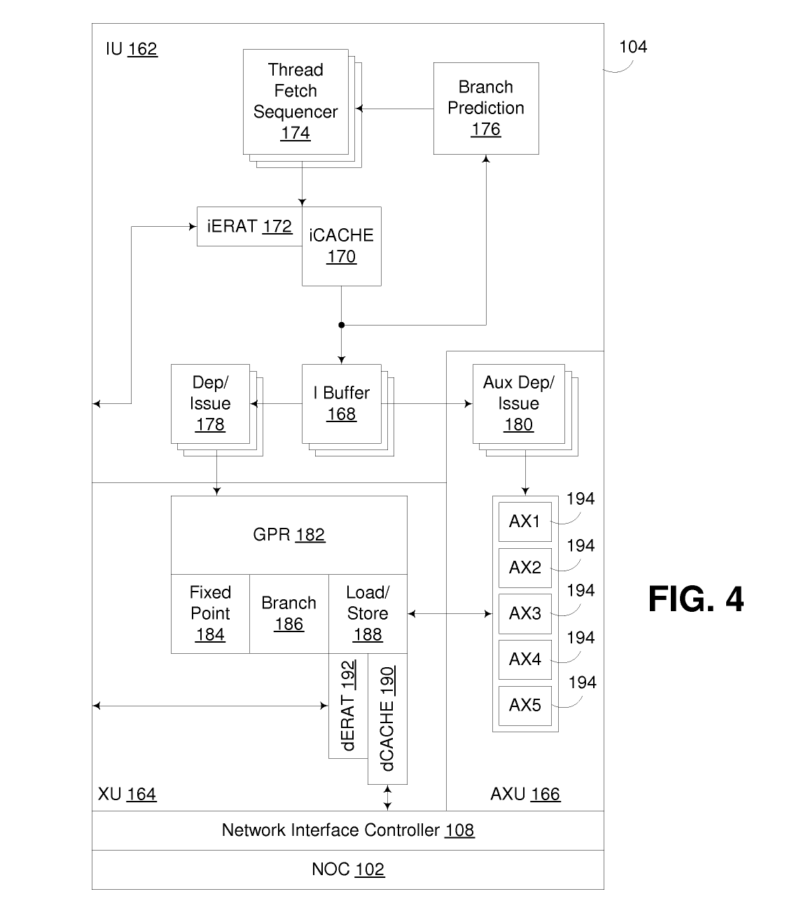

FIG. 4 next illustrates in another manner one exemplary implementation of an IP block 104 consistent with the invention, implemented as a processing element partitioned into an instruction unit (IU) 162, execution unit (XU) 164 and auxiliary execution unit (AXU) 166. In the illustrated implementation, IU 162 includes a plurality of instruction buffers 168 that receive instructions from an L1 instruction cache (iCACHE) 170. Each instruction buffer 168 is dedicated to one of a plurality, e.g., four, symmetric multithreaded (SMT) hardware threads. An effective-to-real translation unit (iERAT) 172 is coupled to iCACHE 170, and is used to translate instruction fetch requests from a plurality of thread fetch sequencers 174 into real addresses for retrieval of instructions from lower order memory. Each thread fetch sequencer 174 is dedicated to a particular hardware thread, and is used to ensure that instructions to be executed by the associated thread is fetched into the iCACHE for dispatch to the appropriate execution unit. As also shown in FIG. 4, instructions fetched into instruction buffer 168 may also be monitored by branch prediction logic 176, which provides hints to each thread fetch sequencer 174 to minimize instruction cache misses resulting from branches in executing threads.

IU 162 also includes a dependency/issue logic block 178 dedicated to each hardware thread, and configured to resolve dependencies and control the issue of instructions from instruction buffer 168 to XU 164. In addition, in the illustrated embodiment, separate dependency/issue logic 180 is provided in AXU 166, thus enabling separate instructions to be concurrently issued by different threads to XU 164 and AXU 166. In an alternative embodiment, logic 180 may be disposed in IU 162, or may be omitted in its entirety, such that logic 178 issues instructions to AXU 166.

XU 164 is implemented as a fixed point execution unit, including a set of general purpose registers (GPR's) 182 coupled to fixed point logic 184, branch logic 186 and load/store logic 188. Load/store logic 188 is coupled to an L1 data cache (dCACHE) 190, with effective to real translation provided by dERAT logic 192. XU 164 may be configured to implement practically any instruction set, e.g., all or a portion of a 32 b or 64 b PowerPC instruction set.

AXU 166 operates as an auxiliary execution unit including dedicated dependency/issue logic 180 along with one or more execution blocks 194. AXU 166 may include any number of execution blocks, and may implement practically any type of execution unit, e.g., a floating point unit, or one or more specialized execution units such as encryption/decryption units, coprocessors, vector processing units, graphics processing units, XML processing units, etc. In the illustrated embodiment, AXU 166 includes a high speed auxiliary interface to XU 164, e.g., to support direct moves between AXU architected state and XU architected state.

Communication with IP block 104 may be managed in the manner discussed above in connection with FIG. 2, via network interface controller 108 coupled to NOC 102. Address-based communication, e.g., to access L2 cache memory, may be provided, along with message-based communication. For example, each IP block 104 may include a dedicated in box and/or out box in order to handle inter-node communications between IP blocks.

Embodiments of the present invention may be implemented within the hardware and software environment described above in connection with FIGS. 1-4. However, it will be appreciated by one of ordinary skill in the art having the benefit of the instant disclosure that the invention may be implemented in a multitude of different environments, and that other modifications may be made to the aforementioned hardware and software embodiment without departing from the spirit and scope of the invention. As such, the invention is not limited to the particular hardware and software environment disclosed herein.

### Issue Rate-Based Thermal Management

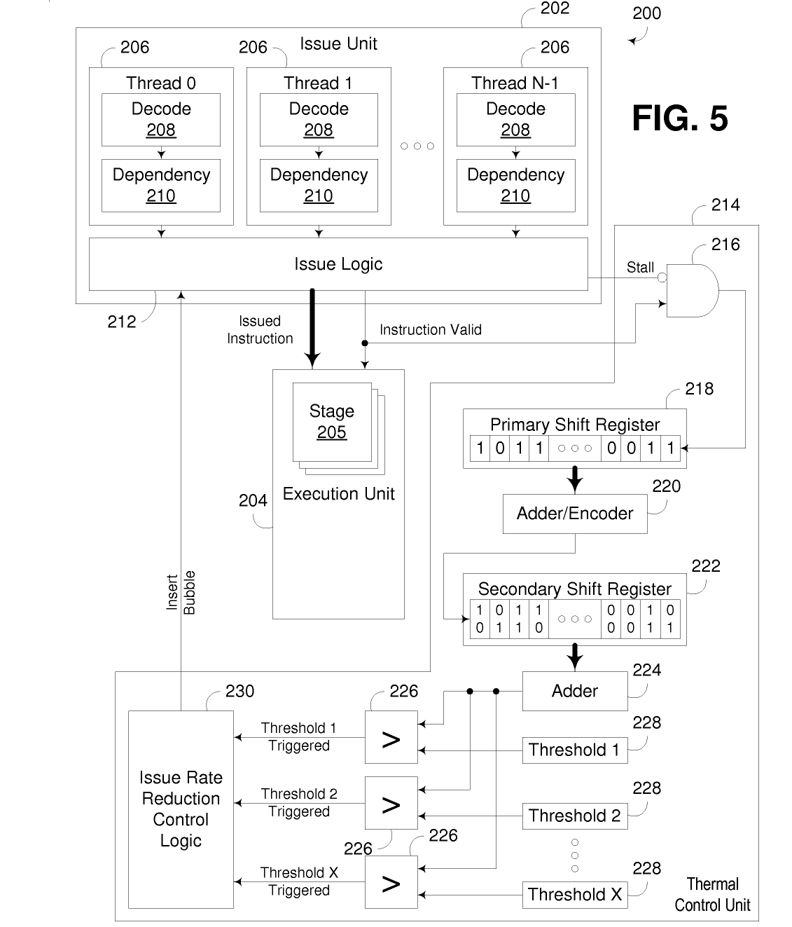

Turning now to FIG. 5, this figure illustrates an exemplary processing unit 200 incorporating issue rate-based predictive thermal management consistent with the invention. Processing unit 200 may be implemented, for example, in an IP block such as an IP block 104 from FIGS. 1-4. In the alternative, processing unit 200 may be implemented in other processor architectures that issue and execute instructions, including single or multi-core microprocessors or microcontrollers.

Processing unit 200 includes issue logic implemented within an issue unit 202 that issues instructions to an execution unit 204. In the illustrated embodiment, execution unit is a pipelined execution unit, and may be implemented as a number of different types of execution units, e.g., a floating point unit, a fixed point unit, a vector unit, a coprocessor, or a specialized unit such as an encryption/decryption unit or graphics processing unit. Execution unit 204 includes a pipeline of stages 205 that executes instructions by sequentially processing the instructions through the stages, in a manner generally understood in the art.

Issue unit 202 supports the issuance of instructions from a plurality of threads 206, and includes, for each supported thread, decode logic 208 that decodes instructions from the thread, and dependency logic 210 that detects dependencies between instructions in the thread. Issue logic 212 is coupled to each thread and serves as an arbiter for the execution unit. During each cycle, the issue logic either selects an instruction from one of the threads and issues that instruction to the execution unit, or inserts a bubble into the execution unit by failing to issue an instruction during that cycle. An “instruction valid” indication is asserted and supplied to the execution unit whenever an instruction has been issued to the execution unit and that instruction is valid. When no instruction is issued, a separate stall indication is asserted, as shown in FIG. 5.

To implement issue rate-based predictive thermal management, control logic implemented as a thermal control unit 214 is coupled to issue unit 202. In other embodiments, the control logic may be partly or completely implemented within the issue and/or execution unit. Thermal control unit 214 includes tracking logic including an AND gate 216, primary shift register 218, adder/encoder 220, secondary shift register 222 and adder 224 that collectively generate a value that is indicative of the rate of issue of instructions from the issue unit to the execution unit.

AND gate 216 functions as instruction issue detection logic, and generates an indication of whether an instruction was issued by the issue logic during each of a plurality of cycles in a sample window. In particular, AND gate 216 receives as input the “instruction valid” indication and an inverted representation of the stall indication, such that a logic “1” is output whenever the issue logic issues a valid instruction to the execution unit in a given cycle. The output of AND gate 216 is shifted into primary shift register 218 such that, during each cycle, a “1” is shifted into the register when a valid instruction has been issued in that cycle; otherwise a “0” is shifted into register 218 for that cycle.

Shift register 218 has a length N corresponding to a sample window size, and represents a cycle by cycle history of issues occurring over the current sample window. After N cycles, adder/encoder block 220 sums the “1” values in the shift register to generate number of issues performed during the N cycle window. In the illustrated embodiment, block 220 also operates as an encoder to generate a code that corresponds to a range of issue rates within which the summed issues over the window falls. For example, adder/encoder block 220 may output a 2-bit code corresponding to four ranges: 00b for 0-24%, 01b for 25-49%, 10 b for 50-74% and 11 b for 75-100%. Thus, for example, if the sample window N were 100 cycles, and 67 issues occurred in a window, adder/encoder block 220 would output a code of 10b.

Therefore, each time the primary shift register's window has been filled, an encoded value or sum output by adder/encoder block 220 is shifted into an M-bit secondary shift register 222. Adder block 224 coupled to secondary shift register 222 then continuously adds the sums or encoded values to produce a running tally representing the issue rate for a relatively large number of cycles, in particular, for a window of N×M cycles. It will be appreciated that the lengths N, M of shift registers 218, 222 may vary in different embodiments, with shorter lengths leading to relatively faster responses, and longer lengths generally leading to greater accuracy. Variable length shift registers may also be used such that the window size is configurable for a particular operating environment.

The running tally of issue percentage, as output by adder block 224, is desirably compared via comparison blocks 226 with multiple pre-configured threshold values 228 that may be stored in software accessible registers such as special purpose registers, SPRS, or may be fixed in hardware. “Threshold triggered” signals are output from comparison blocks 226 and fed into issue rate reduction control logic 230. It will be appreciated that any number of thresholds may be provided, and that the number of active thresholds may be controlled by software if desired.

Issue rate reduction control logic 230 selectively delays issuance of instructions by selectively asserting an “insert bubble” signal to issue logic 212. Issue logic 212 may implement any number of conventional algorithms to handle instruction dependencies and arbitrate between different threads to enable multiple threads to issue instructions to the execution unit on a timely basis. However, issue logic 212 additionally is responsive to the insert bubble signal to override the arbitration algorithm and insert a bubble into the execution unit in lieu of an instruction from one of threads 206. It will be appreciated that in some instances, issue logic 212 may insert bubbles into execution unit 204 even when not so directed to do so by control logic 230, e.g., when dependencies or branches occur that preclude a new instruction from entering the execution unit pipeline. Nonetheless, issue logic 212 is configured such that, even if the arbitration algorithm determines an instruction to be issued to the execution unit in a given cycle, assertion of the insert bubble signal will override that determination and preclude an instruction from being issued to the execution unit for that cycle (resulting also in assertion of the stall indication to AND gate 216). It will be appreciated that a “bubble” is effectively just a cycle where an instruction could be issued, but is skipped for that cycle, while all instructions are stalled.

Control logic 230 and threshold values 228 are typically designed to insert more bubbles (and thus lower issue utilization) for higher thresholds. Low utilization thresholds then produce only occasionally inserted bubbles, where higher thresholds incur more frequently skipped issue opportunities. The net effect of the inserted bubbles is lower issue rate, and thus less signal switching per amount of time in the execution unit, and thus lower power consumption and lower heat.

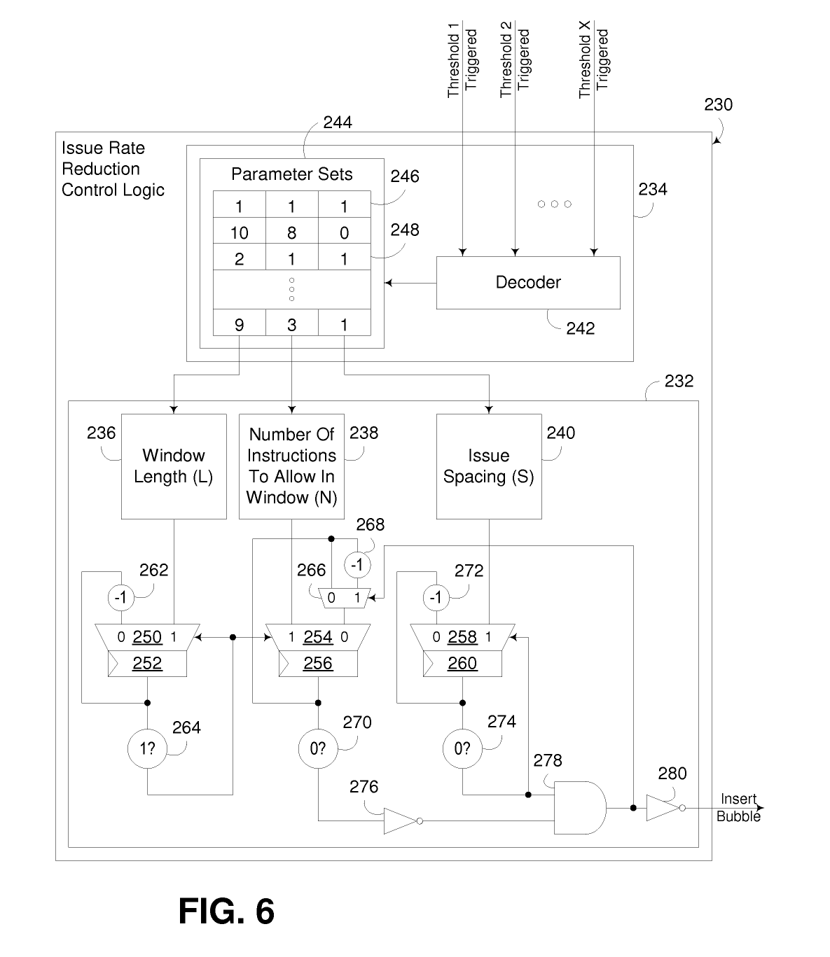

The manner in which issue rate reduction control logic selectively delays issuance of instructions may vary in different embodiments. FIG. 6, for example, illustrates one suitable implementation of control logic 230, incorporating bubble generating logic 232 that is controlled by parameter load logic 234. Bubble generation logic 232 is responsive to three parameters stored in three associated registers 236, 238, 240. These parameters are the window length (L), the number of instructions to allow to be issued per window (N), and the issue spacing (S).

In order to load each register 236, 238, 240, parameter load logic 234 includes a decoder 242 that is coupled to a parameter storage array 244 that stores a plurality of parameter sets, including a default parameter set 246 and a plurality of threshold-associated parameter sets 248. Each parameter set 248 includes each of the L, N and S parameters, and is associated with a particular threshold. Parameter set 246 likewise includes each of the L, N and S parameters, but is associated with no threshold triggered signal being asserted. Default parameter set 246, for example, may specify a 100% issue rate (e.g., L=1, N=1, S=0) so that no reduction in the issue rate is performed by control logic 230. Control logic 230 may be configured, for example, to load new parameters into bubble generation logic 232 every N cycles, such that the logic follows the issue rate as it is updated each time a new code is shifted into shift register 222. It may also be desirable to reset bubble generation logic 232 whenever new parameters are loaded into the registers to start a new window for issuing insert bubble registers to the issue logic.

Bubble generation logic 232 is configured to target a certain issue rate according to the L, N and S parameters stored in registers 236, 238 and 240. L represents a window length, N represents the number of instructions to issue per window, and S represents the number of bubbles to insert between instructions. L Register 236 outputs to a “1” input of a multiplexer 250 coupled to a storage latch 252, with the “0” input of multiplexer 250 coupled to the output of storage latch 252 via a decrementer 262. The output of storage latch 252 is fed to a one detector 264 that controls multiplexer 250 as well as a multiplexer 254 coupled to a storage latch 256, such that the “1” inputs of multiplexers 250 and 254 are selected whenever the value in latch 252 is equal to one.

A “1” input of multiplexer 254 receives the output of N register 238, with the “0” input receiving the output of a multiplexer 266. A “0” input of multiplexer 266 receives the output of storage latch 256, while the “1” input of multiplexer 266 receives a value of one less than the output of storage latch 256, generated by decrementer 268.

Storage latch 256 also drives a zero detector 270 which drives an inverter 276. Inverter 276 drives one input of an AND gate, and thus drives a “0” to the input of AND gate 278 whenever a zero value is stored in storage latch 256.

S register 240 is coupled to the “1” input of a multiplexer 258 coupled to a storage latch 260, with the “0” input of multiplexer 258 coupled to the output of storage latch 260 via a decrementer 272. The output of storage latch 260 also drives a zero detector 274, which outputs a select signal for multiplexer 258, as well as drives the other input of AND gate 278.

The output of AND gate 278 drives an inverter 280, the output of which is asserted whenever it is desirable to insert a bubble in the execution unit. The output of AND gate 278 also serves as a select signal for multiplexer 266.

Elements 250, 252, 262 and 264 operate to track the window and reset the logic at the start of each window. Storage latch 252 initially stores the window length L, and in each successive cycle, decrements its contents through selection of the “0” input of multiplexer 250, which loads the latch via decrementer 262. Once the value in latch 252 equals one, one detector 264 selects the “1” input of multiplexer 250 and on the next cycle reloads the window length L into latch 252 to start a new window.

Elements 254, 256, 266, 268 and 270 operate to track the number of issues performed in a given window, while elements 258, 260, 272 and 274 tick off desired spacings between issues in the window. At the start of a window, N register 238 is loaded into latch 256. As long as issues are still available in the window, zero detector 270 is low, driving one input to AND gate 278 high via inverter 276. Latch 260 is initially loaded with the contents of S register 240, and counts down every cycle via decrementer 272 until zero detector 274 detects a zero value in latch 260, which drives the other input of AND gate 278 high and causes the value of S register 240 to be reloaded into latch 260.

When latch 260 is zero (indicating any required spacing has been accounted for) and latch 256 is not zero (indicating more issues remain in the current window), AND gate 278 outputs high, and drives the select input of multiplexer 266 to decrement latch 256 via decrementer 268 and multiplexers 266, 254, thus logging the issue of an instruction (or non-insertion of a bubble) in latch 256. When latch 260 is not zero (indicating the desired spacing has not yet been placed between issues) or latch 256 is zero (indicating no more issues are permitted for this window), AND gate 278 outputs low, and by virtue of inverter 280, asserts the insert bubble signal to cause issue logic 212 to stall and insert a bubble in execution unit 204.

Thus, for example, parameter values of L=2, N=1 and S=1 would represent a 50% issue availability rate, where the pattern of the insert bubble signal would be “101010 . . . ” For an 80% issue availability rate, parameter values of L=10, N=8, S=0 could be used, resulting in issues potentially occurring in every cycle except the last two cycles of a 10 cycle window, where the state of insert bubble signal over the window would be “0000000011.” For an 33% issue availability rate, parameter values of L=9, N=3, S=1 could be used, resulting in issues potentially occurring in every other cycle for the first half of a nine cycle window, where the state of insert bubble signal over the window would be “101010111.”

It should be noted that an endless number of combinations of parameters could be used to vary the issue availability rate as well as the spread of instructions. It will be appreciated that the spread of instructions may result in different results based on dependencies and other characteristics of instruction stream (e.g., an insert bubble signal of “10101010” may result in different thermal characteristics than “11110000,” despite the same number of bubbles being inserted in the window). Different combinations and types of parameters may also be used in the alternative (e.g., N could be omitted in some embodiments).

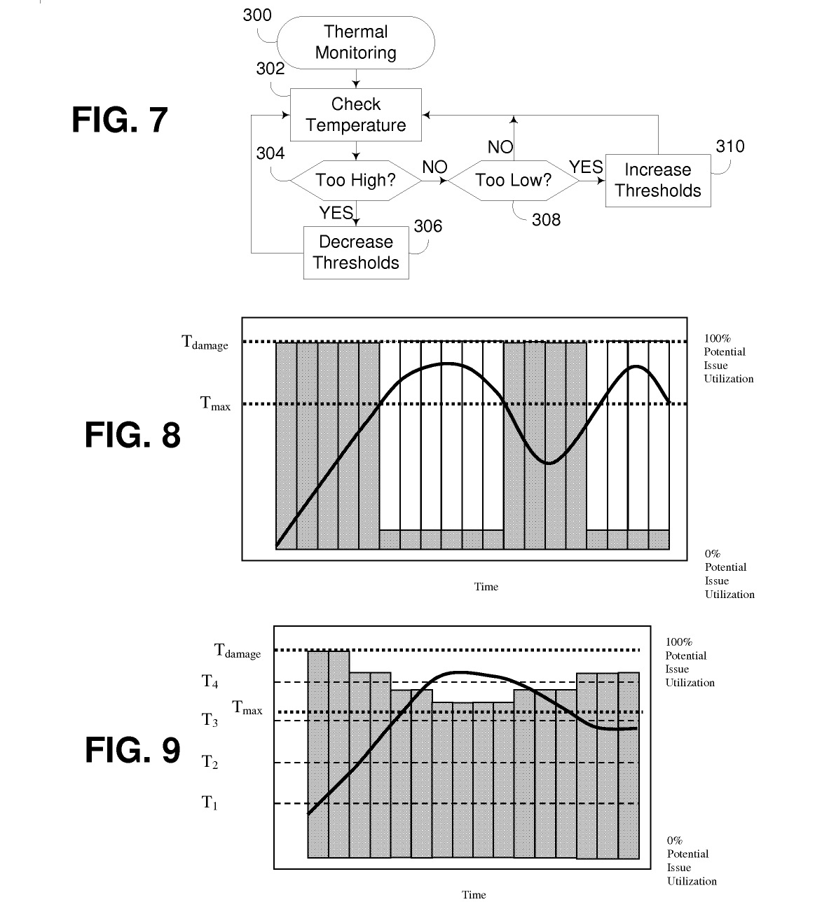

As noted above, processing unit 200 may be customized in some embodiments to be responsive to other feedbacks in addition to issue rate, as well as to adapt to different operating environments. One manner in which different operating environments may be accounted for is through adjusting the threshold values stored in registers 228 of thermal control unit 214 (FIG. 5) responsive to external feedback, e.g. a temperature sensor. FIG. 7, for example, illustrates a thermal monitor routine 300, which may be run in software or may be implemented in hardware. Routine 300 periodically checks the operating temperature in block 302, e.g., via an on-chip or external thermal temperature. If the temperature is determined to be too high in block 304, one or more of the thresholds is decreased in block 306 to implement a more conservative thermal management algorithm. If not, block 308 determines if the temperature is too low, and if so, one or more of the thresholds is increased in block 310 to implement a more aggressive thermal management algorithm. If the temperature is within a desired range, no adjustment of the thresholds occurs.

It will be appreciated that the output of a thermal sensor may also be used to adjust parameters in control logic 230 as an alternate manner of adjusting the algorithm responsive to the detected temperature. In addition, other external feedback, e.g., time of day, may also be used to adjust the algorithm in the manner described in connection with FIG. 7.

To further illustrate the potential performance gains that may be achieved via issue rate-based predictive thermal management, FIG. 8 is a graph of temperature vs. time for an exemplary thermal sensor-based thermal management algorithm, in an integrated circuit that implements conventional single issue thermal throttling, where pipelining is fully disabled whenever the detected temperature exceeds a predetermined threshold. In this graph, the bolded line represents the temperature of the circuit, while the shaded boxes represent the potential issue utilization, which varies between 100% (pipelining enabled) and 0% (pipelining disabled). The graph does not represent actual data values, but is merely illustrative of the general characteristics of a conventional algorithm. In general, with such an algorithm, the threshold temperature at which pipelining is disabled, labeled Tₘₐₓ, is set substantially lower than the temperature that would actually cause damage to the chip (labeled T_{damage}). When the circuit reaches the threshold, the circuit enters single issue mode and the percent of issue availability drops drastically, causing substantial performance loss. In addition, it should be noted that the temperature continues to rise after entering single issue mode due to the lag resulting from the thermal constant of the device. The lower switching due to the throttled issue mode eventually lowers the local temperature below Tₘₐₓ; however, as the example graph shows, there can be significant performance loss and the temperature and performance may wildly oscillate about the threshold temperature.

In contrast with conventional on-chip thermal management techniques that exclusively use a thermal sensor to detect if a processor has reached some threshold and switch to a single issue thermal throttle mode to fully disable pipelining, the illustrated embodiments allow for a more proactive and highly configurable approach that selectively inserts bubbles into a pipelined execution unit based upon a tracked rate of issue of instructions by the issue logic that feeds the execution unit. Thus, as shown in FIG. 9, a series of thresholds, labeled T₁-T₄, may be used to provide finer grained control over issue utilization. Rather than drastically throttling back, issue availability is progressively reduced as thresholds are hit, providing more stable performance as well as more stable temperatures. Furthermore, as illustrated by threshold T₄, due to the increased stability, greater accuracy, and more predictive and proactive nature of the algorithm, thresholds may be established much closer to the temperature at which damage might occur, with a reduced risk of damage to a chip. Throttling generally occurs earlier than would occur responsive to a thermal sensor, and as such, the temperature can be drawn down more quickly to avoid overheating. A greater percentage of the performance envelope (i.e., the area between the current temperature and the temperature at which damage occurs) is utilized, thus leading to better overall performance.

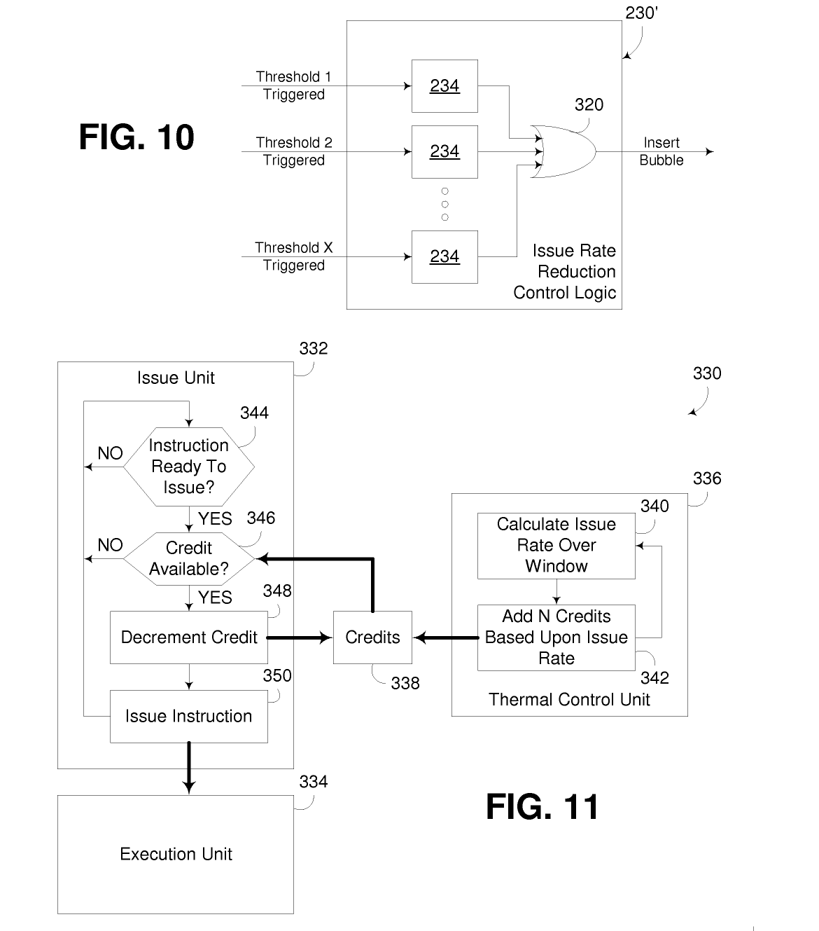

It will be appreciated that various modifications may be made to the illustrated embodiments consistent with the invention. For example, FIG. 10 illustrates an alternate implementation 230′ of issue rate reduction control logic 230 of FIG. 5. In this implementation, rather than loading bubble generation logic 234 (FIG. 6) with parameters stored in parameter load logic, bubble generation logic 234 can be replicated for each threshold trigger signal, with unique parameter sets associated with each trigger signal within each instance of bubble generation logic 234. Each instance of bubble generation logic generates its own insert bubble signal, with the unique insert bubble signals logically combined by an OR gate 320 to generate a combined insert bubble signal. Of note, if no threshold trigger signal is asserted, each bubble generation logic instance may be disabled, such that no throttling occurs in the absence of any threshold being met.

As another alternative, FIG. 11 illustrates another implementation of a processing unit 330 that incorporates an issue unit 332, execution unit 334 and thermal control unit 336. In this implementation, issue unit 332 and thermal control unit may exchange “credits” stored in a register 338, such that issue unit 332 is permitted to issue an instruction during a particular cycle only if a credit is available in register 338. Credits may be added to register 338 by thermal control unit 336 responsive to issue rate tracking in the manner discussed above in connection with FIG. 5, whereby the issue rate is calculated over a window as shown in block 340. During each window, block 342 then adds N credits to credit register 338 based upon the issue rate. The number of credits to be added can be varied depending upon the calculated issue rate. For example, different credit values can be associated with different thresholds, such that, whenever a particular threshold is hit, the credit value associated with that threshold is used to load credit register 338, with higher thresholds providing smaller credits in order to decrease the number of instructions that can be issued by the issue unit in the next window.

Issue unit 332 generally implements a loop that determines in block 344 whether an instruction is ready to issue, and if so, checks in block 346 whether a credit is available in credit register 338. If either condition is not true, no instruction is issued in that clock cycle. Otherwise, block 348 decrements the credit and block 350 issues the pending instruction to execution unit 334. As such, thermal control unit 336 limits the number of instructions that can be issued over particular window of time, thus effectively throttling the issue of instructions responsive to the tracked issue rate.

Various additional modifications may be made without departing from the spirit and scope of the invention. Therefore, the invention lies in the claims hereinafter appended.

What is claimed is:

1. A circuit arrangement, comprising:
a pipelined execution unit including a plurality of stages, wherein each stage is of the type that exhibits reduced switching when a bubble is passed through such stage;
issue logic coupled to the execution unit and configured to issue instructions to the pipelined execution unit, the issue logic further configured to selectively insert bubbles in the pipelined execution unit; and
a thermal control unit coupled to the issue logic, the thermal control unit configured to track a rate of issue of instructions to the pipelined execution unit by the issue logic and to cause the issue logic to selectively insert bubbles in the pipelined execution unit as a function of the tracked rate of issue of instructions to reduce switching in the plurality of stages of the pipelined execution unit and thereby decrease thermal output of the pipelined execution unit.

2. A circuit arrangement, comprising:
an execution unit;
issue logic coupled to the execution unit and configured to issue instructions to the execution unit; and
control logic coupled to the issue logic and configured to track a rate of issue of instructions to the execution unit by the issue logic and to cause the issue logic to selectively delay issuance of instructions to the execution unit based upon the tracked rate of issue of instructions.

3. The circuit arrangement of claim 2, wherein the execution unit comprises a pipelined execution unit including a plurality of stages, wherein each stage exhibits reduced switching when a bubble is passed through such stage, and wherein the control logic is configured to cause the issue logic to selectively delay issuance of instructions to the execution unit by causing the issue logic to selectively insert bubbles in the pipelined execution unit.

4. The circuit arrangement of claim 3, wherein the control logic comprises:
instruction issue detection logic configured to generate an indication of whether an instruction was issued by the issue logic during each of a plurality of cycles in a sample window;
a primary shift register coupled to the instruction issue detection logic and configured to store the indication of whether an instruction was issued by the issue logic during each of the plurality of cycles in the sample window;
a first adder coupled to the primary shift register and configured to generate a sum from the primary shift register representative of a number of instructions issued by the issue logic during the sample window;
a secondary shift register coupled to the first adder and configured to store an output of the first adder for each of a plurality of sample windows; and
a second adder coupled to the secondary shift register and configured to generate a sum of the outputs of the first adder for each of the plurality of sample windows.

5. The circuit arrangement of claim 4, wherein the control logic further comprises:
issue rate reduction control logic responsive to at least one threshold trigger signal and configured to selectively generate an insert bubble signal that causes the issue logic to selectively insert bubbles in the pipelined execution unit; and
comparison logic coupled intermediate the second adder and the issue rate reduction control logic, the comparison logic configured to generate the threshold trigger signal responsive to a comparison between an output of the second adder and a threshold.

6. The circuit arrangement of claim 5, wherein the issue rate reduction control logic is responsive to a plurality of threshold trigger signals and configured to select from among a plurality of issue availability rates responsive to the plurality of threshold trigger signals, and wherein the comparison logic is configured to generate the plurality of threshold trigger signals responsive to comparisons between the output of the second adder and a plurality of thresholds.

7. The circuit arrangement of claim 4, wherein the first adder includes an encoder configured to generate as the output of the first adder an encoded representation of issue rate from the sum generated by the first adder.

8. The circuit arrangement of claim 3, wherein the control logic includes bubble generation logic configured to selectively generate an insert bubble signal that causes the issue logic to selectively insert bubbles in the pipelined execution unit, the bubble generation logic configured to generate the insert bubble signal to control an issue availability rate for the issue logic that is selected from among more than two issue availability rates.

9. The circuit arrangement of claim 8, wherein the bubble generation logic is configured to generate the insert bubble signal based upon a window length parameter, an instruction number parameter and an issue spacing parameter, and wherein the window length parameter, instruction number parameter and issue spacing parameter number associated with a threshold, wherein the control logic is configured to use the window length parameter, instruction number parameter and issue spacing parameter when the tracked rate of issue of instructions meets the threshold.

10. The circuit arrangement of claim 2, wherein the control logic comprises a thermal control unit configured to cause the issue logic to selectively delay issuance of instructions to the execution unit as a function of the tracked rate of issue of instructions to reduce switching in the execution unit and thereby decrease thermal output of the execution unit.

11. The circuit arrangement of claim 2, wherein the control logic is configured to control the issue logic responsive to the tracked rate of issue of instructions based upon a plurality of thresholds.

12. The circuit arrangement of claim 11, wherein the control logic is further configured to adjust at least one of the thresholds responsive to input other than the tracked rate of issue of instructions.

13. The circuit arrangement of claim 2, wherein the control logic is configured to control an issue availability rate for the issue logic that is selected from among more than two issue availability rates.

14. An integrated circuit device including the circuit arrangement of claim 1.

15. A program product comprising a computer readable medium and logic definition program code resident on the computer readable medium and defining the circuit arrangement of claim 1.

16. A method of executing instructions in a circuit arrangement of the type including issue logic configured to issue instructions to an execution unit, the method comprising:
tracking a rate of issue of instructions to the execution unit by the issue logic; and
causing the issue logic to selectively delay issuance of instructions to the execution unit based upon the tracked rate of issue of instructions.

17. The method of claim 16, wherein the execution unit comprises a pipelined execution unit including a plurality of stages, wherein each stage exhibits reduced switching when a bubble is passed through such stage, and wherein causing the issue logic to selectively delay issuance of instructions to the execution unit includes causing the issue logic to selectively insert bubbles in the pipelined execution unit.

18. The method of claim 17, wherein tracking the rate of issue of instructions includes:
counting a number of instructions issued by the issue logic during a sample window;
generating an encoded value representative of issue rate based upon the number of instructions issued by the issue logic during the sample window; and
summing a plurality of encoded values generated during a plurality of sample windows.

19. The method of claim 17, wherein causing the issue logic to selectively delay issuance of instructions to the execution unit based upon the tracked rate of issue of instructions includes adjusting an issue availability rate for the issue logic based upon at least one threshold.

20. The method of claim 19, wherein causing the issue logic to selectively delay issuance of instructions to the execution unit based upon the tracked rate of issue of instructions includes adjusting the issue availability rate for the issue logic based upon a plurality of thresholds, each threshold associated with a different issue availability rate.

21. The method of claim 17, wherein causing the issue logic to selectively delay issuance of instructions to the execution unit based upon the tracked rate of issue of instructions includes selectively generating an insert bubble signal that causes the issue logic to selectively insert bubbles in the pipelined execution unit, wherein the insert bubble signal is based upon a window length parameter, an instruction number parameter and an issue spacing parameter.

22. The method of claim 16, wherein causing the issue logic to selectively delay issuance of instructions to the execution unit based upon the tracked rate of issue of instructions includes causing the issue logic to selectively delay issuance of instructions to the execution unit as a function of the tracked rate of issue of instructions to reduce switching in the execution unit and thereby decrease thermal output of the execution unit.

23. The method of claim 16, wherein causing the issue logic to selectively delay issuance of instructions to the execution unit based upon the tracked rate of issue of instructions is based upon a plurality of thresholds.

24. The method of claim 23, further comprising adjusting at least one of the thresholds responsive to input other than the tracked rate of issue of instructions.

25. The method of claim 16, wherein causing the issue logic to selectively delay issuance of instructions to the execution unit based upon the tracked rate of issue of instructions includes controlling an issue availability rate for the issue logic that is selected from among more than two issue availability rates.
